(19) United States
(12) Patent Application Publication
(10) Pub. No.: US 2016/0045294 A1
(43) Pub. Date: Feb. 18, 2016

(54) PET LIFT DEVICE WITH A TRANSPORT MODE AND A STATIONARY LOCATION MODE

(71) Applicant: Fran Sherman, Maryland Heights, MO (US)

(72) Inventor: Fran Sherman, Maryland Heights, MO (US)

(21) Appl. No.: 14/460,835

(22) Filed: Aug. 15, 2014

(51) Int. Cl. A61D 3/00; A01K 13/00

(52) U.S. Cl. CPC A61D 3/00; A01K 13/00

(57) ABSTRACT

There is provided a pet assist device that facilitates the transport of a pet between locations while continuously maintaining the pet in a comfortable posture in which pain inducing movements and weight bearing problems are greatly minimized. The pet assist device is in the form of a pet lift device that includes a chassis, a translation movement element, and a rigging structure.

### BACKGROUND OF THE INVENTION

U.S. Pat. No. 6,216,636 to Butchko discloses a device for assisting four-legged pets to walk during periods of convalescence from foot, leg, or hip surgery or injury. A sling portion is connected to two handle grips. The sling portion may be disposed under the chest of the animal in the case of debilitated front legs, or under the abdomen in the case of debilitated hind legs, and the handle grips grasped by a human user to help support or lift the pet. The device is particularly useful for assisting a convalescent pet to take beneficial walks without having to bear full weight on Injured limbs or hip.

According to U.S. Pat. No. 6,216,636 to Butchko, pets occasionally suffer from injury, disease, or genetic defects which cause them difficulty in walking. Dogs, particularly, with unfortunate frequency, suffer injury to their legs, making walking difficult. Also, dogs sometimes experience hip displasia and other hip disorders, requiring corrective surgery. When dogs are convalescing from injury and/or surgery, they nevertheless must be moved about, and preferably also are permitted a daily walk to promote proper healing and provide other benefits to both the pet and the pet owner.

U.S. Pat. No. 4,530,309 to Collins discloses a multi-piece harness device that includes a collar portion placed around a dog's neck and a belly band portion which completely surrounds the animal's thorax. A handle is attached to the belly band to permit the user to assist the animal, for example, while climbing stairs. U.S. Pat. No. 4,559,906 to Smith discloses a small animal harness featuring a pair of vertical straps that wrap virtually completely around the trunk or thorax of the animal, and a third strap connected to the first to that passes around the front of the animal. Buckles or snaps or the like are used to secure the device around the animal. A handle is attached to the two vertical straps, and the animal may be carried thereby.

U.S. Pat. No. 4,644,902 to Doyle shows a pet carrier including a pouch-like portion having four holes therein through which the animal's legs are inserted. A pair of straps, joined by a buckle, extend from the pouch and when connected together serve as a looped handle. The device is intended for use to lift the animal completely clear of the ground for carrying.

U.S. Pat. No. 6,216,636 to Butchko notes that veterinary professionals employ a common household towel, slung beneath the animal's abdomen, as a simple sling with which to lift or walk an injured dog. However, as can be readily grasped, it would highly impractical in many circumstances for a pet owner to employ the same technique including the reasons that the weight of the pet will put the pet owner at risk of self-injury, the task is quickly tiring to the pet owner, and the task does not permit the pet owner to quickly transition to other tasks. Thus, there is a need for a new and improved approach to offering assistance to pets, especially in circumstances in which the mobility and stability of the pet is diminished, while at the same time offering practicality and convenience to the pet owner. Moreover, the general health and healing progress of an injured pet can be accelerated in many circumstances if the pet can still perform some limited movements while nonetheless not being subjected to undue strain or weight bearing loads.

### SUMMARY OF THE INVENTION

The present invention solves the above-mentioned problems by providing a pet assist device that effectively relieves many of the weight bearing and stability problems that can beset pets, especially those pets whose mobility and stability capabilities are diminished.

It is one object of the present invention to provide a pet assist device that permits a pet to still perform some limited movements while nonetheless not being subjected to undue strain or weight bearing loads.

It is a further object of the present invention to provide a pet assist device that facilitates the transport of a pet between locations while continuously maintaining the pet in a comfortable posture in which pain inducing movements and weight bearing problems are greatly minimized.

According to one aspect of the present invention, there is provided a pet assist device in the form of a pet lift device that includes a chassis, a translation movement element, and a rigging structure.

According to further features of the one aspect of the present invention, the pet lift device further includes an adjustment element for selectively varying the spacing of at least one portion of the animal in a nested position on the device from a platform under the animal, whereupon the degree to which the animal must bear its own weight can be effectively selected and controlled.

According to another aspect of the present invention, there is provided a pet assist device that includes: a) a transport arrangement for providing rolling movement along a travel surface such as the floor of a house or a building or a road surface, b) a stretcher arrangement for supporting an animal to be raised or lowered, c) a bed arrangement for providing a stand alone stationary bed on which an animal can rest, d) an incontinence assistant arrangement to collect or wick away moisture from incontinence so that an animal remains clean and dry, and e) a position varying arrangement for varying the profile of the stretcher arrangement to thereby to assist in preventing pressure sores on the animal.

The present invention is generally directed towards a convenient and practical pet assist device. The principles of the present invention, however, are not limited to the particular configurations of the pet assist device described herein. Additionally, to assist in the description of the pet assist device of the present invention, words such as top, bottom, front, rear, right and left may be used to describe the accompanying figures, which may be but are not necessarily drawn to scale. It will be appreciated that the pet assist device can also be used as a stand-alone device or used in combination with pet assistance arrangements.

### BRIEF DESCRIPTION OF THE DRAWINGS

Other features and advantages of the invention will become apparent to those skilled in the art upon review of the following detailed description, claims, and drawings.

FIG. 1 is a front perspective view of one embodiment of the pet assist device of the present invention;

FIG. 2 is a front perspective view of the one embodiment of the pet assist device of the present invention shown in FIG. 1 and showing a pet in a nested position in the device;

FIG. 3 is a side perspective view of the one embodiment of the pet assist device of the present invention shown in FIG. 2;

FIG. 4 is a side perspective view of the sling of the one embodiment of the pet assist device of the present invention shown in FIGS. 2 and 3;

FIG. 5 is a side perspective view of a portion of the one embodiment of the pet assist device of the present invention shown in FIGS. 2 and 3; and

FIG. 6 is a hydraulic scissor jack arrangement of the one embodiment of the pet assist device of the present invention shown in FIG. 1.

### DETAILED DESCRIPTION OF AN EMBODIMENT

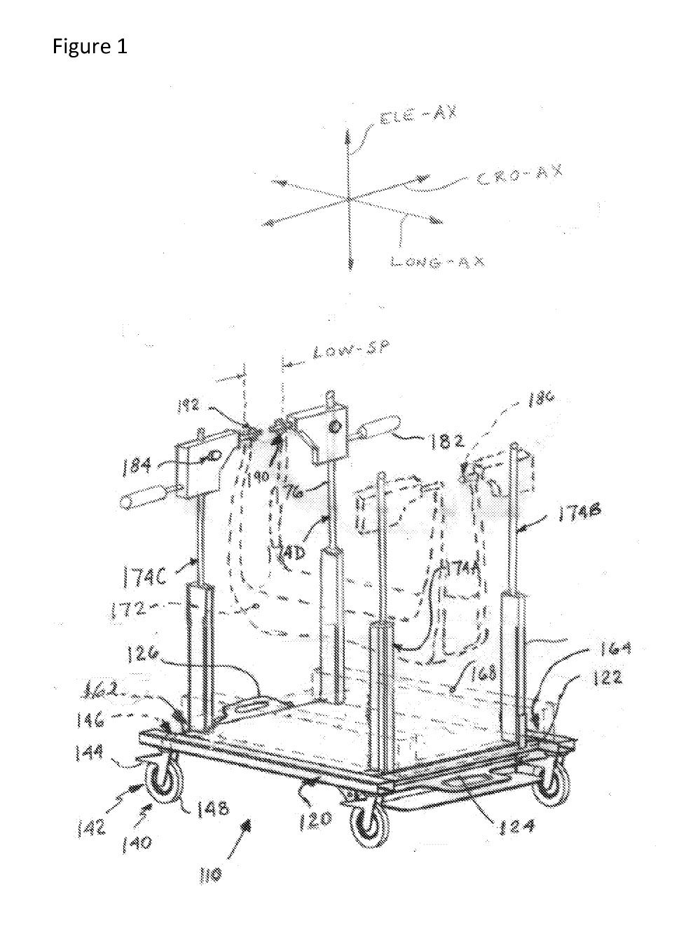

The pet assist device fulfills the long-felt need for a product for supporting and transporting an animal including both animals not typically found in a domesticated situation and animals found in domesticated situations, such as a pet dog or the like. In addition to performing the beneficial tasks of supporting and transporting an animal and, in particular, a disabled or physically challenged animal, the pet assist device can optionally be provided with features that even further ease the tasks of supporting and transporting the animal. The one embodiment of the pet assist device that is described herein includes several of these optional capabilities including the capability: 1) to function with the ease of a child stroller in moving along a travel surface such as the floor of a house or a building or a road surface, 2) to function with the flexibility of a stretcher or a gurney in permitting a supported animal to be raised or lowered so that, for the supported animal can be more easily transferred between the pet lift device 110 and a vehicle such as a car or a van, 3) to function with the comfort and longevity of a durable and comfortable stationary bed, 4) to wick away moisture from incontinence so that animal remains clean and dry, and 5) to assist in preventing pressure sores on the animal. These several desirable features, which are denominated, respectively, as 1) a Transport feature, 2) a Stretcher feature, 3) a Bed feature, 4) an incontinence Assistant feature, and 5) a Bed Sore Prevention, will be described in more detail herein. However, the pet assist device will initially be described with reference to one configuration thereof that includes an exemplary group of basic features. The description will make reference to a coordinate reference system schematically shown in FIG. 1 that includes a longitudinal axis LONG-AX, a crosswidth axis CRO-AX perpendicular to the longitudinal axis LONG-AX, and an elevation axis ELE-AX perpendicular to the longitudinal axis LONG-AX and the crosswidth axis CRO-AX.

With reference to FIGS. 1-6, the pet assist device, which is hereinafter generally designated as the pet lift device 110, includes a chassis 120, a translation movement element 140, and a rigging structure 160. The chassis 120 has an underside and a top side and is configured in the one embodiment of the pet assist device as a relatively rigid rectilinear frame 122 having a forward pulling handle 124 extending from a front side of the frame and a reverse pulling handle 126 extending from a rear side of the frame. The forward pulling handle 124 and the reverse pulling handle 126 are each engageable by a user of the pet lift device 110 to manually move the pet lift device 110 in a translation manner along a travel surface in a respective forward or reverse direction.

The translation movement element 140 is configured in the one embodiment of the pet assist device as a plurality of swivel capable wheel assemblies 142 that are secured to the chassis 120. Each wheel assembly 142 includes a mounting yoke 144 rotatably mounted in an associated mounting bore 146 formed in a respective one of the four corners of the frame 122 of the chassis 120 and a wheel 148 secured to the yoke for rotation about an axis that lies in a plane delimited by the longitudinal axis LONG-AX and the crosswidth axis CRO-AX. Each wheel assembly 142 is operable to facilitate translatory movement of the chassis 120 along a travel surface as the underside of the chassis 120 is in facing orientation to the travel surface.

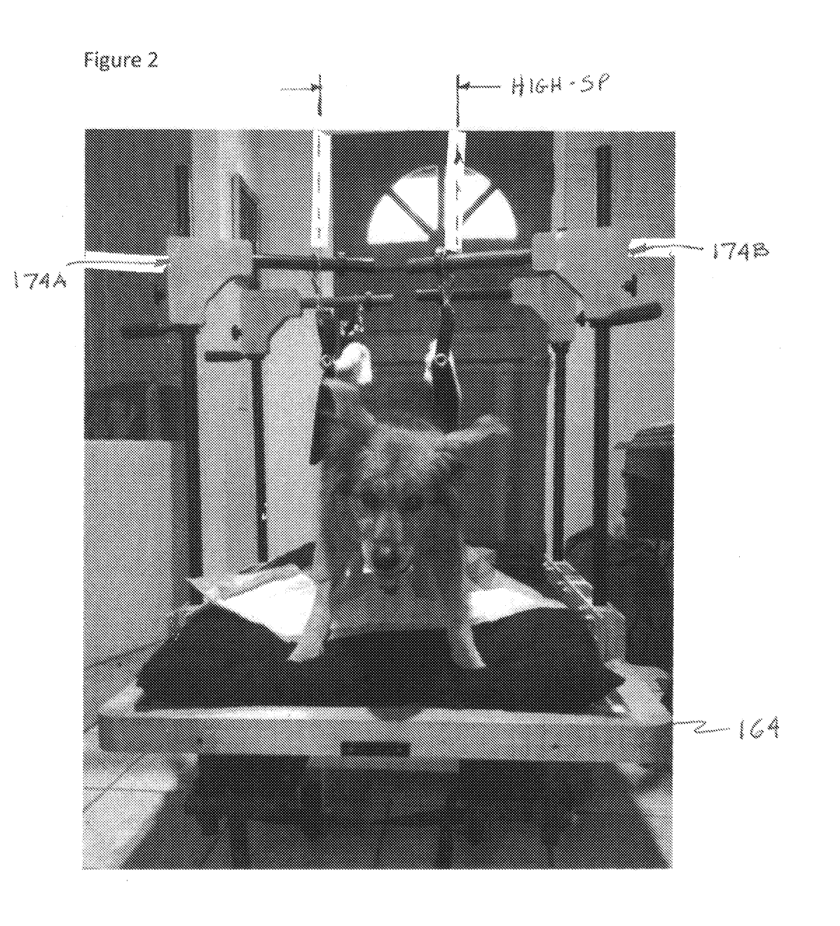

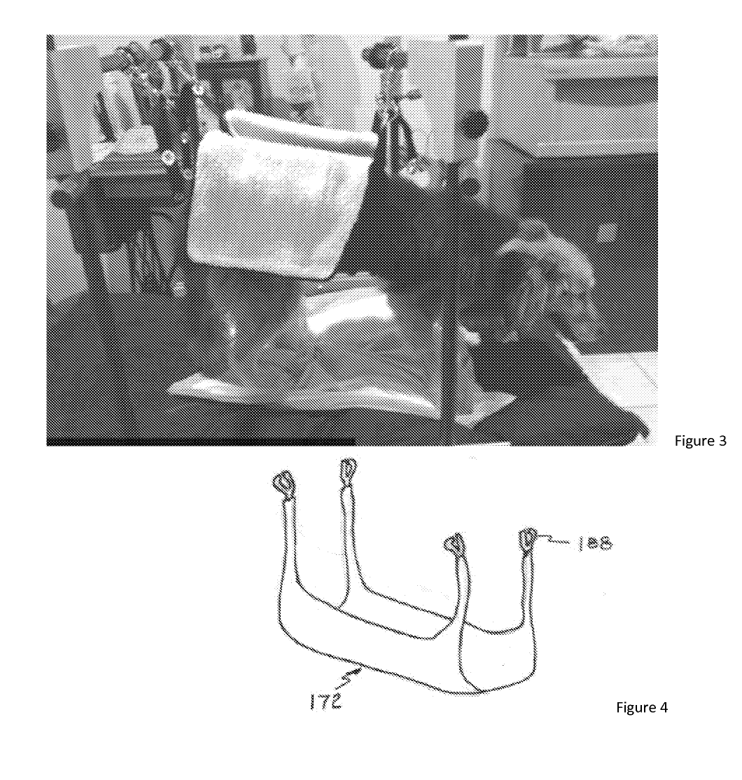

The rigging structure 160 has a base element 162 that, as configured in the one embodiment of the pet assist device, includes a bed platform 164. The rigging structure 160 is mounted on the chassis 120 such that the chassis 120 is intermediate the base element 162 of the rigging structure 160 and the travel surface, as viewed along the elevation axis ELE-AX. Thus, in the event that the pet lift device 110 is being moved along a travel surface that is horizontal, the chassis 120 is at a higher elevation than the travel surface and the base element 162 of the rigging structure 160 is higher than the chassis 120. The bed platform 164 is configured in the one embodiment of the pet assist device with a four-sided rectilinear platform delimiting a top surface area suitable for receiving and retaining thereon an upholstered or cushioned product such as, for example, a pillow 166 as seen in FIGS. 2 and 3. The bed platform 164 also includes a pair of retaining walls 168 spaced from one another as viewed along the crosswidth axis CRO-AX and extending parallel to the longitudinal axis LONG-AX, the retaining walls 168 operating to help maintain the pillow 166 in a centered disposition on the bed platform 164.

The rigging structure 160 also includes a weight bearing arrangement 170 operable to receive an animal in a nested position thereon and the weight bearing arrangement operates to support the animal in the nested position at a spacing from, or at a predetermined degree of contact with, the base element 162 of the rigging structure 160. As seen in FIG. 7, the weight bearing arrangement 170 is configured in the one embodiment of the pet assist device as a suspension element—which is in the form of a sling assembly 172—and a plurality of lift anchors 174A-D on which the sling assembly 172 is mounted. The weight bearing arrangement 170 further includes an adjustment element for selectively varying the spacing of at least one portion of the animal in the nested position from the base element 162 of the rigging structure 160.

The rigging structure 160 is securable to the chassis 120 in a manner in which the rigging structure and the chassis can be detached from one another and this securement arrangement can be implemented via any suitable arrangement. As will be described shortly herein, the securement arrangement for reversibly securing the rigging structure 160 to the chassis 120 is, in the one embodiment of the pet assist device, a convenient disconnect and reconnect arrangement.

The suspension element comprised of the sling assembly 172 is operable to extend across a portion of the animal in the nested position—namely, as seen in FIGS. 2 and 3, the sling assembly 172 can extend across the chest of an animal (exemplarily shown as a domesticated dog and designated as the dog PET). FIG. 4 shows further details of the sling 172. As seen in FIG. 1, the lift anchors 174A-D include a first lift anchor 174A having a connection location at which a first portion of the sling assembly 172 is connectable thereto in a manner in which the weight of the dog PET in the nested position on the sling assembly 172 is transmitted to the first lift anchor 174A. The first lift anchor 174A assists in maintaining at least one portion of the dog PET in the nested position at a spacing from, or at a predetermined degree of contact with, the base element 162 of the rigging structure 160.

If desired, a second portion of the sling assembly 172 can be connected to the lift anchor 174A so that, while the rigging structure 160 and the chassis 120 are detached from one another, the first lift anchor 174A continues to maintain at least one portion of the dog PET in the nested position at a spacing from, or at a predetermined degree of contact with, the base element 162 of the rigging structure 160. However, for the sake of Illustration, the one embodiment of the pet assist device is shown as providing a configuration wherein all of the lift anchors 174A-D are engaged with the sling 172 so that, while the rigging structure 160 and the chassis 120 are detached from one another, these lift anchors 174A-D continue to maintain the entirety of the dog PET in the nested position at a predetermined degree of contact with the base element 162 of the rigging structure 160—specifically, a degree of contact in which the paws of the dog PET contact the base element 162 yet substantially all of the mass of the dog PET is supported by the sling 172.

In connection with further details of the adjustment element of the weight bearing arrangement 170 of the rigging structure 160, the weight bearing arrangement 170 includes a structure for varying the spacing between the connection locations of a pair of the lift anchors 174A-D and the spacing of at least a portion of the dog PET in the nested position from the base element 162 of the rigging structure 160 varies in response to a variation in the spacing between the connection locations of these lift anchors. As seen in FIG. 1, each lift anchor 174A-D includes a post 176 that extends along the elevation axis ELE-AX and each lift anchor 174A-D is provided with a projecting arm 180.

As seen in particular in FIG. 1, each projecting arm 180 is formed with a bore in which the respective post 176 is slidably received such that the projecting arm 180 can slide along the respective post 176 to thus be re-positioned at a greater spacing from the base element 162 of the rigging structure 160 or re-positioned at a lesser spacing from the base element 162 of the rigging structure 160, as viewed along the elevation axis ELE-AX. Each projecting arm 180 is configured to move along the elevation axis ELE-AX (via sliding movement along the respective post 176) and, additionally, is configured to be pivoted about the respective post 176 (i.e., pivoted about an axis parallel to the elevation axis ELE-AX). These dual modes of movement of each projecting arm 180 provide the capability to vary the spacing between the connection locations of a given pair of the lift anchors 174A-D and thereby vary the spacing of at least a portion of the dog PET in the nested position from the base element 162 of the rigging structure 160 varies in response to a variation in this connection locations spacing, as will be described in more detail herein.

For ease of moving each projecting arm 180 along the elevation axis ELE-AX (via sliding movement along the respective post 176) and pivoting the projecting arm 180 about the respective post 176, each projecting arm 180 has a maneuver handle 182 secured to a lower side of the projecting arm 180 that can be grasped by a user to raise or lower the projecting arm 180 or to pivot the projecting arm 180. A set bolt 184 is threadably secured to each projecting arm 180 and can be threaded into engagement with the respective post 176 on which the projecting arm 180 is mounted to thereby effect a reversible securement of the projecting arm 180 to the respective post 176 at a selected spacing of the projecting arm 180 from the base element 162 of the rigging structure 160. Each projecting arm 180 includes a lateral tube 186 that extends in a direction parallel to the plane delimited by the crosswidth axis CRO-AX and the longitudinal axis LONG-AX.

As seen in FIG. 1, the actual securement of the sling 172 to each lift anchor 174A-D is, as configured in the one embodiment of the pet assist device, effected via reversibly securing a “D” ring spring-biased clasp 188 fastened to a strap of the sling 172 to a steel coil 190 that is slidably mounted on the lateral tube 186 of the projecting arm 180. Each lateral tube 186 includes a stop flange 192 that has a larger radius than the remainder of the lateral tube and the stop flange 192 operates to prevent the respective steel coil 190 slidably mounted on the lateral tube from sliding off the free end of the lateral tube.

To vary the spacing between the connection locations of the first lift anchor 174A and the second lift anchor 174B, a user manipulates the maneuver handle 182 of each lift anchor to selectively raise, lower, and/or pivot the lift anchor relative to the respective post 176 on which it is mounted. It can be understood that the steel coil 190 on the lateral tube 186 of the projecting arm 180 of each respective lift anchor 174A-D is constrained by the sling 172 as the lateral tube 186 changes its orientation and/or position relative to the elevation axis ELE-AX and this action brings about a re-positioning of the steel coil 190 on the lateral tube 186 and/or a consequent flexing movement of the sling 172. The term “flexing of the sling 172” is intended to refer to the circumstance in which the sling 172 undergoes a change in its profile as a result of a movement of one or more of the steel coils 190. For example if the projecting arm 180 of the lift anchor 174A is rotated about its respective post 176 in a manner that causes the respective steel coil 190 thereon to slide relatively along the lateral tube, this action will cause the respective portion of the sling 172 secured to this steel coil 190 to be urged to move while the remainder of the sling 172 remains connected to the other lift anchors 174B-D. While the steel coils 190 on these other lift anchors 174B-D are free to move in response to this movement, and may well move, the combination of the mass or weight of the dog PET on the sling 172 and frictional resistance resisting movement of these other steel coils 190 will often result in an accommodation by the sling 172 in the form of a change in the profile of the sling. Such a change in profile may be a movement of the sling 172 from a more cupped disposition to a more elongated, less cupped disposition, whereupon this re-configuration of the profile of the sling 172 will bring about a lilting of the dog PET.

FIG. 1 shows an example of how selective raising, lowering, or pivoting of associated pairs of the lift anchors 174A-D can dispose the sling 172 in such a relatively more cupped or lowered disposition. With reference to the associated pair of the lift anchors 174C and 174D as shown in FIG. 1, the sling 172 in such a relatively more cupped disposition and this has been achieved via positioning of the lateral tube 186 of the projecting arm 180 of the third lift anchor 174C such its free end toward the fourth lift anchor 174D (i.e., the lateral tube 186 of the projecting arm 180 of the third lift anchor 174C is parallel to the crosswidth axis CRO-AX) and positioning of the lateral tube 186 of the projecting arm 180 of the fourth lift anchor 174D with its free end toward the third lift anchor 174C (i.e., the lateral tube 186 of the projecting arm 180 of the fourth lift anchor 174D is parallel to the crosswidth axis CRO-AX) ensures that the portion of the sling 172 secured to this associated pair of the lift anchors 174C and 174D will be in a relatively more cupped or lowered disposition. The spacing between the connection locations of these associated pair of the lift anchors 174C and 174D (i.e., the locations at which the sling 172 is secured to the lift anchors) is, as measured along the crosswidth axis CRO-AX, a spacing LOW-SP.

The sling 172 can be flexed from a relatively more cupped disposition to a relatively more taut or elongated disposition and this will bring about a lifting of the dog PET which is in the nested position supported on the sling 172. FIGS. 2 and 3 show the sling 172 in such a relatively more taut or elongated disposition. The lateral tube 186 of the projecting arm 180 of the first lift anchor 174A is, in this scenario, oriented at a forty-five degree angle to the crosswidth axis CRO-AX and the lateral tube 186 of the projecting arm 180 of the second lift anchor 174B is oriented at a forty-five degree angle to the crosswidth axis CRO-AX. The spacing between the connection locations of these associated pair of the lift anchors 174A and 174B (i.e., the locations at which the sling 172 is secured to the lift anchors) is, as measured along the crosswidth axis CRO-AX, a spacing HIGH-SP and this spacing is greater than the spacing LOW-SP between the connection locations of the associated pair of the lift anchors 174C and 174D shown in FIG. 1.

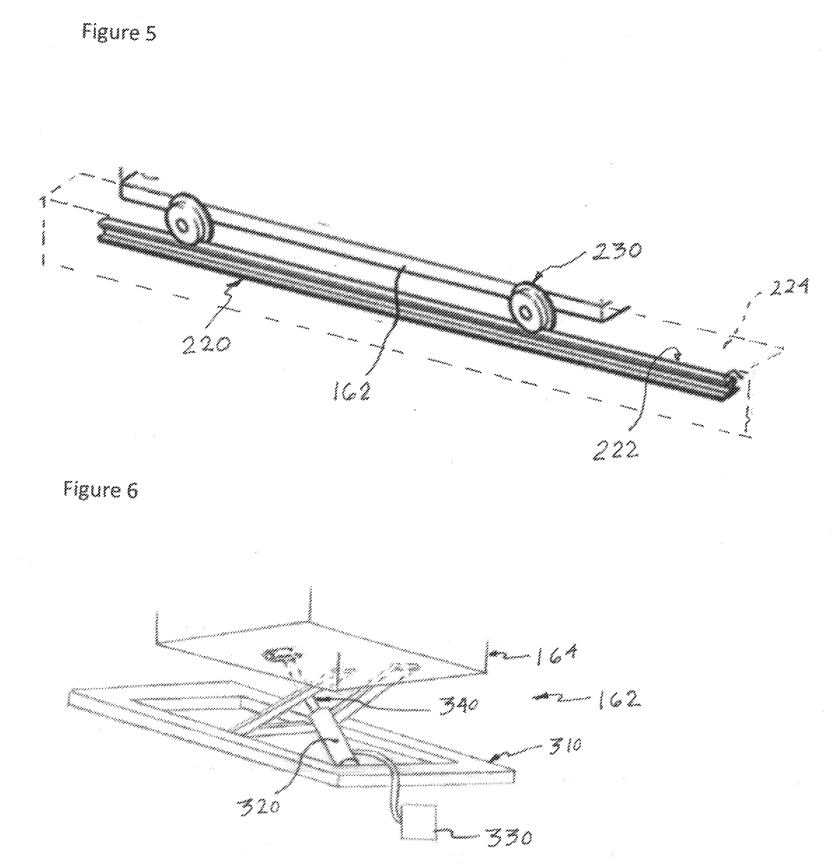

The chassis 120 and the rigging structure 160 are reversibly secured to one another in a manner in which the rigging structure 160 can be conveniently removed from the chassis 120. As seen in FIG. 5, the chassis 120 includes a pair of rails 220 extending parallel to one another as viewed in the direction of the longitudinal axis LONG-AX and spaced from one another as viewed in the direction of the cross width axis CRO-AX. The rigging structure 160 includes two rows of roller wheels 230 fixedly secured to the underside of the base element 162, each row of the roller wheels 230 being oriented so as to be co-axial with a respective one of the rails 220 on the chassis 120. Each rail 220 includes a lower flat-topped flange 222 along which the roller wheels 230 can roll and each rail 220 delimits a guide channel in which the roller wheels 230 of a respective row of the roller wheels secured to the platform 164 can be received. Each guide channel includes a necked-in top portion 224 that overhangs the roller wheels 230, whereupon each roller wheel 230 is received within the guide channel with its mounting yoke extending through the central longitudinal slot and each roller wheel 230 can roll longitudinally along the rail 220 but is constrained by the necked-in top portion 224 of the guide channel from being withdrawn from the rail 220 in the direction of the elevation axis ELE-AX. The rigging structure 160 can be removed from the chassis 120 by moving the rigging structure 160 along the longitudinal axis LONG-AX until all of the roller wheels 230 have cleared past one longitudinal end of each rail 220. Once removed in this manner, the rigging structure 160 can function as a stand-alone support to comfortably support the dog PET in the nested position.

The manner in which the rigging structure 160 is moved in the direction of the elevation axis ELE-AX (i.e., raising or lowering movement of the rigging structure 160) can be effected in any suitable fashion. One example of a mechanism for accomplishing this movement is shown in FIG. 6, wherein it can be seen that the base element 162 of the rigging structure 160 includes a hydraulic scissor jack arrangement for selectively raising and lowering the platform 164. The base element 162 includes a base frame 310 having an underside on which the two rows of the roller wheels 230 are mounted. The platform 164, which has a flat planar underside, is compatibly configured with respect to the base frame 310 such that the platform 164 can lie on and be supported in a stable manner by the base frame.

The hydraulic scissor jack arrangement includes a cylinder 320 operatively connected to a hydraulic fluid source and control assembly 330 and having one end fixedly secured to the base frame 310. A piston 340 is slidably secured within the cylinder 320 and has a free axial end highly connected to the underside of the platform 164. The piston 340 can be selectively extended from, and retracted into, the cylinder 320 via controlled inflow and outflow of hydraulic fluid relative to the cylinder 320, whereupon it can be understood that extension of the piston 340 effects a raising of the platform 164 and retraction of the piston 340 effects a lowering of the platform 164. Since the base element 162 comprises both the cylinder 320 and the piston 340. It can be seen that the rigging structure 160 can still be raised and lowered in the event that the rigging structure 160 is fully removed from the chassis 120.

The several desirable features of the pet assist device, which have been denominated, respectively, as: 1) a Transport feature, 2) a Stretcher feature, 3) a Bed feature, 4) an Incontinence Assistant feature, and 5) a Bed Sore Prevention, are described in more detail as follows:
1) The Transport feature: The pet assist device comprises a large bed supported by a solid frame. It has four wheels and a pulling handle that allow a person to easily move an assisted pet around. There is also a second pulling handle on the opposite side to facilitate moving the pet in extra difficult circumstances where an additional person's assistance may be needed, i.e., going up or down flights of stairs. The handles on both sides also facilitate a reversal of direction. There is a small ramp between the wheels on each side that facilitates rolling the animal onto the main bed. A sturdy silng/harness is attached to the bed frame by four sturdy hooks at each corner of the sling. An assisted pet is placed on top of this, and if desired, the two bottom hooks can be unhooked and the comfortable, padded sling can be wrapped around the pet and hooked above the pet to keep the pet securely in place.
2) The Stretcher feature: Under the bed is a frame that has a hydraulic lift system operated by an easy-to-operate pedal. The hydraulic lift raises the entire bed up to three (3) feet high so that the pet can be easily moved into a car, van, hospital
3) bed, etc. without the need to separate cradle and lift the pet off the bed and then raising the cradled pet. The stretcher portion has small wheels on tracks, much like a dove-tailed drawer, so the stretcher portion can easily detach from the bottom frame, and the pet can actually stay on it for transport. The bottom frame then can fold and be stored in the trunk or back of the vehicle. The stretcher then easily re-attaches to the tracks of the frame.
4) The Bed feature: The bed material is a breathable mesh that has air between the bed and stainless steel “pan” below.
5) The Incontinence Assistance feature: There is a removable stainless steel pan beneath the breathable mesh so that pet waste material drops directly into the easily-cleanable pan, and fluid is wicked away immediately. Alternatively, a person can place an absorbent tissue “potty pad” beneath the breathable mesh. The stainless steel pan can be easily removed for cleaning.
6) Bed Sore Prevention: The sling that resides on top of the bed is connected at four corners to posts that can rise to the height a dog requires to “stand” upright comfortably. The pet lies on the sling with front legs on one side of the sling, and rear legs on the other side. As the four posts raise up, the sling supports the pet as the pet starts to move into an upright position. In order to move the pet upright so that the head of the pet comes up first, the two posts on the head side
7) can be raised up faster than the two posts on the legs side. Once the animal is approaching the upright position, the leg side posts are raised evenly with the head side. Then, four horizontal extensions at the top of the posts move inward toward the dog to stabilize the pet in the upright position. The pet assist device can also advantageously take pressure off an animal's hips and prevent pressure sores.

Although this invention has been disclosed and described in its preferred forms with a certain degree of particularity, it is to be realized that the optimum dimensional relationships for the parts of the invention, to include variations in size, materials, shape, form, function and manner of operation, assembly and use, are deemed readily apparent and obvious to one skilled in the art. Additionally, it is understood that the present disclosure of the preferred forms is only by way of example and that numerous changes in the details of operation and in the combination and arrangement of parts may be resorted to without departing from the spirit and scope of the Invention as hereinafter claimed.

What is claimed is:

1. An animal assist device comprising:
a chassis, the chassis having an underside and a top side;
a translation movement element, the translation movement element being secured to the chassis and operable to facilitate translatory movement of the chassis along a travel surface as the underside of the chassis is in facing orientation to the travel surface;
a rigging structure, the rigging structure having a base element and the rigging structure being mounted on the chassis such that the chassis is intermediate the base element of the rigging structure and the travel surface, the rigging structure having a weight bearing arrangement operable to receive an animal in a nested position thereon and the weight bearing arrangement operating to support the animal in the nested position at a spacing from, or at a predetermined degree of contact with, the base element, and the weight bearing arrangement including an adjustment element for selectively varying the spacing of at least one portion of the animal in the nested position from the base element.

2. The animal assist device according to claim 1, wherein the weight bearing arrangement of the rigging structure includes a suspension element operable to extend across a portion of the animal in the nested position and the rigging structure includes a first lift anchor having a connection location at which a first portion of the suspension element is connectable thereto in a manner in which the weight of the animal in the nested position on the suspension element is transmitted to the first lift anchor and the first lift anchor assists in maintaining the at least one portion of the animal in the nested position at a spacing from, or at a predetermined degree of contact with, the base element of the rigging structure.

3. The animal assist device according to claim 2, wherein the rigging structure is securable to the chassis in a manner in which the rigging structure and the chassis can be detached from one another and, while the rigging structure and the chassis are detached from one another, the first lift anchor continues to maintain the at least one portion of the animal in the nested position at a spacing from, or at a predetermined degree of contact with, the base element of the rigging structure.

4. The animal assist device according to claim 2, wherein the rigging structure includes a second lilt anchor having a connection location at which a second portion of the suspension element is connectable thereto in a manner in which the weight of the animal in the nested position on the suspension element is partially transmitted to the first lift anchor and partially transmitted to the second lift anchor, the first lift anchor and the second lift anchor assist in maintaining the at least one portion of the animal in the nested position at a spacing from, or at a predetermined degree of contact with, the base element of the rigging structure, and the adjustment element of the weight bearing arrangement of the rigging structure includes a structure for varying the spacing between the connection locations of the first lift anchor and the second lift anchor and the spacing of the at least one portion of the animal in the nested position from the base element of the rigging structure varies in response to a variation in the spacing between the connection locations of the first lift anchor and the second lift anchor.

5. A pet assist device comprising:
a transport arrangement for providing rolling movement along a travel surface such as the floor of a house or a building or a road surface;
a stretcher arrangement for supporting an animal to be raised or lowered:
a bed arrangement for providing a stand alone stationary bed on which an animal can rest;
an incontinence assistance arrangement to collect or wick away moisture from incontinence so that an animal remains clean and dry; and
a position varying arrangement for varying the profile of the stretcher arrangement to thereby to assist in preventing pressure sores on the animal.
